(19) United States
(12) Patent Application Publication
(10) Pub. No.: US 2026/0291735 A1
(43) Pub. Date: Sep. 24, 2026

(54) BLOCKCHAIN-BASED COMMUNICATION METHOD AND APPARATUS

(71) Applicant: CHINA UNIONPAY CO., LTD., Shanghai (CN)

(72) Inventors: Shengjiao CAO, Shanghai (CN); Yu ZHOU, Shanghai (CN); Yong MIN, Shanghai (CN); Gang SUN, Shanghai (CN)

(21) Appl. No.: 19/476,578

(22) PCT Filed: Mar. 22, 2024
(86) PCT No.: PCT/CN2024/083406

§ 371 Date: Oct. 17, 2025

(30) Foreign Application Priority Data
Apr. 18, 2023 (CN) 202310416809.1

(51) Int. Cl. H04L 9/32; G06F 16/27; H04L 9/00

(52) U.S. Cl. CPC H04L 9/32; G06F 16/27; H04L 9/50

(57) ABSTRACT

The present disclosure provides a blockchain-based communication method and apparatus. The method includes: a first blockchain node receives a first transaction request, the first transaction request including a blockchain transaction type and first data, and the blockchain transaction type being used for indicating a processing mode for the first data; the first blockchain node stores the first data in a mass storage node, and determines an identifier for the first data; and the first blockchain node synchronizes a first block including the blockchain transaction type and the identifier for the first data to at least one second blockchain node. In the solution, the first block contains the identifier for the first data instead of including the first data, so that the solution reduces data redundancy, reduces the blockchain storage cost, and improves the synchronization speed of blockchain nodes.

### CROSS-REFERENCE TO RELATED APPLICATION

This application claims priority to Chinese Patent Application No. 202310416809.1 entitled “BLOCKCHAIN-BASED COMMUNICATION METHOD AND APPARATUS,” filed on Apr. 18, 2023, the entire content of which is incorporated herein by reference.

### FIELD OF THE DISCLOSURE

The present disclosure generally relates to the field of distributed technology and, more particularly, relates to a blockchain-based communication method and apparatus.

### BACKGROUND

In many distributed application scenarios, data processing on the blockchain is required. Generally, before processing data, the data must be stored on the blockchain. However, due to the characteristics of the blockchain, the data to be processed must be stored on each blockchain node. This results in data redundancy, increases blockchain storage cost, and reduces synchronization speed between blockchain nodes.

### SUMMARY

The present disclosure provides a blockchain-based communication method and apparatus to reduce data redundancy, lower blockchain storage cost, and improve the synchronization speed between blockchain nodes.

In a first aspect, an embodiment of the present disclosure provides a blockchain-based communication method, which may be executed by a communication apparatus, which may be a terminal device or a module for a terminal device, or a server or a module for a server. This present disclosure does not limit the execution entity of this method. The method includes: a first blockchain node receiving a first transaction request, the first transaction request including a blockchain transaction type and first data, the blockchain transaction type being used to indicate a processing mode for the first data; the first blockchain node storing the first data in a mass storage node and determining an identifier for the first data; and the first blockchain node synchronizing a first block including the blockchain transaction type and the identifier for the first data to at least one second blockchain node.

In the above solution, the first blockchain node stores the first data in a mass storage node, and synchronizes the first block to at least one second blockchain node. The first block includes the identifier for the first data instead of the first data. Therefore, the first blockchain node and the at least one second blockchain node just need to store the identifier for the first data, and do not need to store the first data. Subsequently, when the first blockchain node and the at least one second blockchain node need to use or process the first data, the first blockchain node and the at least one second blockchain node may obtain the first data from the mass storage node according to the identifier for the first data. Therefore, this solution reduces data redundancy, reduces blockchain storage cost, and improves the synchronization speed between blockchain nodes.

In one possible implementation, the first blockchain node obtains the blockchain transaction type and the identifier for the first data from the first block; the first blockchain node obtains the first data from the mass storage node based on the identifier for the first data; and the first blockchain node processes the first data based on the blockchain transaction type.

In the above solution, a communication protocol exists between the first blockchain node and the mass storage node, so the first blockchain node and the mass storage node may communicate with each other. When the first blockchain node needs to process the first data, the first blockchain node accurately obtains the first data from the mass storage node according to the identifier for the first data. The first blockchain node itself does not need to store the first data. Therefore, this solution reduces the data redundancy of the first blockchain node and reduces the blockchain storage cost.

In one possible implementation, the first blockchain node receives the identifier for the first data from the mass storage node.

In the above solution, the mass storage node generates the identifier for the first data when storing the first data and returns the identifier for the first data to the first blockchain node, which may accurately determine the identifier for the first data.

In one possible implementation, the first blockchain node generates the identifier for the first data.

In the above solution, the first blockchain node generates the identifier for the first data, which may accurately determine the identifier for the first data.

In one possible implementation, the first transaction request also includes a verification identifier.

In one possible implementation, a determination is made as to whether the verification identifier is identical to the identifier for the first data. When the verification identifier is identical to the identifier for the first data, the first blockchain node synchronizes the first block to the at least one second blockchain node.

In the above solution, when the verification identifier is identical to the identifier for the first data, it indicates that the first data stored in the mass storage node has not been tampered with, thereby increasing the security of the first data and improving the accuracy of the first blockchain node and the at least one second blockchain node in obtaining the first data from the mass storage node.

In one possible implementation, the first blockchain node receives a second transaction request, where the second transaction request includes the blockchain transaction type and the identifier for the first data; and the first blockchain node synchronizes a second block including the blockchain transaction type and the identifier for the first data to the at least one second blockchain node.

In the above solution, after receiving the second transaction request, the first blockchain node directly synchronizes the second block including the blockchain transaction type and the identifier for the first data to the at least one second blockchain node, without the need for storage of the first data again. On the one hand, this saves space on the mass storage node, and on the other hand, this speeds up the synchronization of the second block to the at least one second blockchain node.

In one possible implementation, the mass storage node refers to an InterPlanetary File System (IPFS) node.

In the above solution, IPFS is a content-addressable peer-to-peer hypermedia distribution protocol, that is, data of multiple identical contents will merely be stored in several IPFS nodes, which not only saves resource overhead, but also can store more data, and further can realize the storage of a large amount of data.

In one possible implementation, the first block is used by the at least one second blockchain node to process the first data according to the blockchain transaction type.

In the above solution, a communication protocol exists between the at least one second blockchain node and the mass storage node, so at least one second blockchain node and the mass storage node may communicate with each other. When the at least one second blockchain node needs to process the first data, the at least one second blockchain node accurately obtains the first data from the mass storage node according to the identifier for the first data. The at least one second blockchain node itself does not need to store the first data. Therefore, this solution reduces data redundancy of the at least one second blockchain node and reduces blockchain storage cost.

In a second aspect, an embodiment of the present disclosure provides a communication apparatus, including: a transceiver unit and a processing unit. The transceiver unit is configured to receive, at a first blockchain node, a first transaction request including a blockchain transaction type and first data, the blockchain transaction type indicating a processing mode for the first data; the processing unit is configured to store the first data in a mass storage node and determine an identifier for the first data; and the first blockchain node synchronizes a first block including the blockchain transaction type and the identifier for the first data to at least one second blockchain.

In one possible implementation, the processing unit is further configured to cause the first blockchain node to obtain the blockchain transaction type and the identifier for the first data from the first block; cause the first blockchain node to obtain the first data from the mass storage node based on the identifier for the first data; and cause the first blockchain node to process the first data based on the blockchain transaction type.

In one possible implementation, the transceiver unit is further configured to cause the first blockchain node to receive the identifier for the first data from the mass storage node.

In one possible implementation, the processing unit is further configured to generate the identifier for the first data at the first blockchain node.

In one possible implementation, the first transaction request also includes a verification identifier.

In one possible implementation, the processing unit is further configured to determine whether the verification identifier is identical to the identifier for the first data, when the verification identifier is identical to the identifier for the first data, the first blockchain node synchronizes the first block to the at least one second blockchain node.

In one possible implementation, the transceiver unit is further configured to cause the first blockchain node to receive a second transaction request, where the second transaction request includes the blockchain transaction type and the identifier for the first data; the first blockchain node synchronizes a second block including the blockchain transaction type and the identifier for the first data to the at least one second blockchain node.

In one possible implementation, the mass storage node refers to an IPFS node.

In one possible implementation, the first block is used by the at least one second blockchain node to process the first data according to the blockchain transaction type.

In a third aspect, an embodiment of the present disclosure further provides a computing device, including: a memory for storing program instructions; and a processor for calling the program instructions stored in the memory and executing the obtained program instructions to implement any of the methods of the first aspect described above.

In a fourth aspect, an embodiment of the present disclosure further provides a computer-readable storage medium having computer-readable instructions stored therein, where, when a computer reads and executes the computer-readable instructions, any of the methods of the first aspect described above is implemented.

In a fifth aspect, an embodiment of the present disclosure further provides a computer program product, including a computer program executable by a computer device, where, when the program is run on the computer device, the computer device executes any of the methods of the first aspect described above.

### BRIEF DESCRIPTION OF THE DRAWINGS

FIG. 1 is a flowchart of a blockchain-based communication method according to an embodiment of the present disclosure;

FIG. 2 is a flowchart of a blockchain-based communication method according to an embodiment of the present disclosure;

FIG. 3 is a schematic structural diagram of a communication apparatus according to an embodiment of the present disclosure; and

FIG. 4 is a schematic structural diagram of a communication apparatus according to an embodiment of the present disclosure.

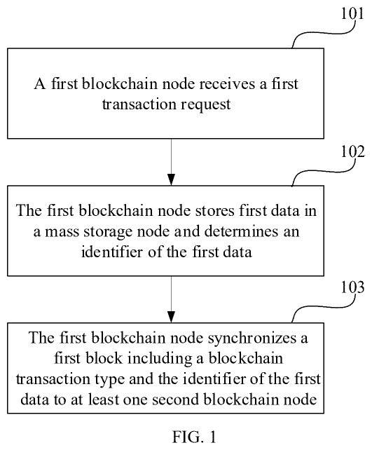

### DETAILED DESCRIPTION

Figure (FIG.) 1 is a flowchart of a blockchain-based communication method according to an embodiment of the present disclosure. The method may be executed by a communication apparatus, which may be a terminal device or a module for a terminal device, or a server or a module for a server. The present disclosure does not limit the execution entity of the method.

The method includes the following steps.
Step 101: A first blockchain node receives a first transaction request.

The first transaction request includes a blockchain transaction type and first data, and the blockchain transaction type is used to indicate a processing mode for the first data.

In one possible implementation, the first blockchain node refers to any consensus node on a blockchain. A blockchain is a decentralized, distributed system typically used to record transactions. The contents of these transactions are recorded as blocks of data, which are independently verified by a peer-to-peer computer network and then added to the blockchain. To ensure that all participants (or nodes) in a blockchain network agree on a single version of history, the network implements a consensus mechanism, also known as a consensus protocol or consensus algorithm. Blockchain nodes that implement this consensus mechanism are called consensus nodes. Consensus nodes may be thought of as special, ordinary time nodes. In addition to performing the tasks of ordinary time nodes, these nodes also need to reach a consensus protocol to update the ledger.

In one possible implementation, the blockchain transaction type is used to indicate how the first data is processed. For example, if it is necessary to verify a user's identity information, the first data includes the user's ID card information, academic certificate information, or degree certificate information, and the blockchain transaction type is to verify the user's identity information based on the user's ID card information, academic certificate information, or degree certificate information. For another example, for a certain financing user, it is necessary to verify whether the financing user's monthly financing amount meets the requirement, the first data is the financing bills of the financing user for one month, and the blockchain transaction type is to verify whether the financing user's monthly financing amount meets the requirement based on the financing bills of the financing user for one month. The present disclosure does not limit the blockchain transaction type, nor does it limit the specific content of the first data.
Step 102: The first blockchain node stores the first data in a mass storage node and determines an identifier for the first data.

In one possible implementation, a mass storage node refers to a node with a distributed storage function, which avoids the risks of trust centralization, single point failure, data loss or tampering brought about by the use of centralized storage.

In one possible implementation, the mass storage node refers to an IPFS node. IPFS is a content-addressable peer-to-peer hypermedia distribution protocol, which means that data with the same content will merely be stored in several IPFS nodes. This not only saves resource overhead, but also allows for the storage of more data, further enabling the storage of a large amount of data. Each file stored in the IPFS system may be identified by the hash value of its content. This hash value is called a content identifier (CID), which is the identifier for the first data.

In one possible implementation, the first blockchain node receives the identifier for the first data from the mass storage node. For example, if the mass storage node is an IPFS node, the first blockchain node sends a storage request to the IPFS node, requesting that the first data be stored there. After the IPFS system stores the first data there, the IPFS system performs a hash calculation based on the content of the first data to determine a hash value, i.e., the identifier for the first data, and then returns the identifier to the first blockchain node. This solution, in which the mass storage node generates the identifier for the first data when storing it and returns it to the first blockchain node, enables accurate determination of the identifier for the first data.

In another possible implementation, the first blockchain node generates the identifier for the first data. For example, the first blockchain node determines a hash value of the first data, i.e., the identifier for the first data, through a hash calculation based on the content of the first data. Alternatively, the first blockchain node determines the identifier for the first data using other methods. The present disclosure does not limit the method for determining the identifier for the first data, as long as the identifier for the first data uniquely represents the first data. In this solution, the first blockchain node determines the identifier for the first data, which may accurately determine the identifier for the first data.
Step 103: The first blockchain node synchronizes a first block including the blockchain transaction type and the identifier for the first data to at least one second blockchain node.

In one possible implementation, a consensus protocol is executed between a first blockchain node and at least one second blockchain node to package transactions and determine a first block, where the first block includes the blockchain transaction type and the identifier for the first data. The packaged first block is then synchronized to the at least one second blockchain node. The at least one second blockchain node and the first blockchain node each execute the transactions in the first block.

In one possible implementation, the first blockchain node and the at least one second blockchain node obtain the blockchain transaction type and the identifier for the first data from the first block. The first blockchain node and the at least one second blockchain node obtain the first data from the mass storage node based on the identifier for the first data. The first blockchain node and the at least one second blockchain node process the first data based on the blockchain transaction type. In this solution, there is a communication protocol between the first blockchain node and the mass storage node, so the two nodes may communicate with each other. When the first blockchain node needs to process the first data, the first blockchain node will accurately obtain the first data from the mass storage node according to the identifier for the first data, and the first blockchain node itself does not need to store the first data. Therefore, this solution reduces the data redundancy of the first blockchain node and reduces the blockchain storage cost.

In one possible implementation, the first transaction request is in the form of a smart contract, and the blockchain transaction type represents the logic of the smart contract, that is, the logical relationship for processing the first data according to the smart contract. The first blockchain node and the at least one second blockchain node execute the transactions in the first block according to the logic of the smart contract and process the first data. This solution, through the form of a smart contract, may enable the first blockchain node and the at least one second blockchain node to communicate with the mass storage node over the network, so that the first blockchain node and the at least one second blockchain node may accurately obtain the first data and process the first data, thereby ensuring the correct execution of the business logic.

In the above solution, the first blockchain node stores the first data in the mass storage node and synchronizes the first block to the at least one second blockchain node. The first block contains the identifier for the first data, rather than the first data. Therefore, the first blockchain node and the at least one second blockchain node just need to store the identifier for the first data, and do not need to store the first data. When the first blockchain node and the at least one second blockchain node need to use or process the first data later, the two nodes may obtain the first data from the mass storage node according to the identifier for the first data. Therefore, this solution reduces data redundancy, reduces blockchain storage cost, and improves the synchronization speed between blockchain nodes.

In one possible implementation, the first transaction request also includes a verification identifier. The verification identifier may be a hash value determined by hash calculation based on the content of the first data, or a verification identifier determined according to a certain rule. The present disclosure does not limit the method for determining the verification identifier and the form of the verification identifier, as long as the verification identifier can verify whether the identifier for the first data is legal. Whether the identifier for the first data is legal refers to whether the identifier for the first data can uniquely identify the content of the first data. If the identifier for the first data can uniquely identify the content of the first data, the identifier for the first data is legal. Otherwise, the identifier for the first data is illegal. After determining that the identifier for the first data is legal, the first blockchain node synchronizes the first block to the at least one second blockchain node.

In one possible implementation, when a client sends a first transaction request to the first blockchain node, the client generates a verification identifier, writes the verification identifier into the first transaction request, and sends the first transaction request to the first blockchain node.

In another possible implementation, the client sends a first transaction request to the communication apparatus, the server of the communication apparatus receives the first transaction request, generates a verification identifier based on the first data carried in the first transaction request, then writes the verification identifier into the first transaction request, and then sends the first transaction request to the first blockchain node.

In one possible implementation, it is determined whether the verification identifier is identical to the identifier for the first data. If the identifier for the first data is identical to the verification identifier, then the identifier for the first data is legal, which means that when the first data is stored in the mass storage node, the content of the first data has not been tampered with. If the identifier for the first data is not identical to the verification identifier, then the identifier for the first data is illegal. That is, when the first data is stored in the mass storage node, the content of the first data has been tampered with, and the first data stored in the mass storage node is wrong.

In the above solution, when the verification identifier is identical to the identifier for the first data, it indicates that the first data stored in the mass storage node has not been tampered with, thereby increasing the security of the first data and improving the accuracy of the first blockchain node and the at least one second blockchain node in obtaining the first data from the mass storage node.

In one possible implementation, when the verification identifier is identical to the identifier for the first data, the first blockchain node synchronizes the first block to the at least one second blockchain node. After the synchronization is completed, the first blockchain node and the at least one second blockchain node obtain the blockchain transaction type and the identifier for the first data from the first block. The first blockchain node and the at least one second blockchain node respectively send a request to obtain data to the mass storage node, namely the IPFS system, where the request to obtain data includes the identifier for the first data. The IPFS system reads the first data from the IPFS node based on the identifier for the first data, and returns the first data to the first blockchain node and the at least one second blockchain node respectively. After the first blockchain node and the at least one second blockchain node respectively obtain the first data, the first blockchain node and the at least one second blockchain node process the first data according to the blockchain transaction type. After the processing of the first data is completed, the processing result is returned to the client.

In one possible implementation, when the verification identifier is different from the identifier for the first data, the first blockchain node will not synchronize the first block to the at least one second blockchain node, but will return a message to the client indicating that the verification identifier is different from the identifier for the first data, waiting for subsequent processing by the client, such as the client initiating a second transaction request.

In one possible implementation, the first blockchain node receives a second transaction request, and the second transaction request includes the blockchain transaction type and the identifier for the first data. At this time, the second transaction request does not include the first data because the first data has been stored in the mass storage node, so there is no need to store the first data again. In this solution, after receiving the second transaction request, the first blockchain node directly synchronizes a second block including the blockchain transaction type and the identifier for the first data to at least one second blockchain node, without the need for storage of the first data again. On the one hand, this saves space in the mass storage node, and on the other hand, this speeds up the synchronization of the second block to at least one second blockchain node.

In one possible implementation, the first blockchain node synchronizes the second block including the blockchain transaction type and the identifier for the first data to at least one second blockchain node. After the synchronization is completed, the first blockchain node and the at least one second blockchain node obtain the blockchain transaction type and the identifier for the first data from the second block. The first blockchain node and the at least one second blockchain node respectively send a request to obtain data to the mass storage node, namely the IPFS system, and the request to obtain data includes the identifier for the first data. The IPFS system reads the first data from the IPFS node according to the identifier for the first data, and returns the first data to the first blockchain node and the at least one second blockchain node respectively. After the first blockchain node and the at least one second blockchain node respectively obtain the first data, the two nodes process the first data according to the blockchain transaction type. After the processing of the first data is completed, the processing result is returned to the client.

In one possible implementation, the second transaction request also includes a second verification identifier, which is used to verify whether the identifier for the first data has changed during the network transmission process. The second verification identifier may be a hash value determined by hash calculation based on the content of the first data, or may be a second verification identifier determined according to a certain rule. The present disclosure does not limit the method for determining the second verification identifier or the form of the second verification identifier, as long as the second verification identifier can verify whether the identifier for the first data in the second transaction request has changed during the network transmission process. After determining that the identifier for the first data in the second transaction request has not changed during the network transmission process, the first blockchain node synchronizes the second block to the at least one second blockchain node.

In one possible implementation, when the second verification identifier is identical to the identifier for the first data in the second transaction request, the first blockchain node synchronizes the second block to the at least one second blockchain node.

The following uses a specific example to illustrate how to process the first data.

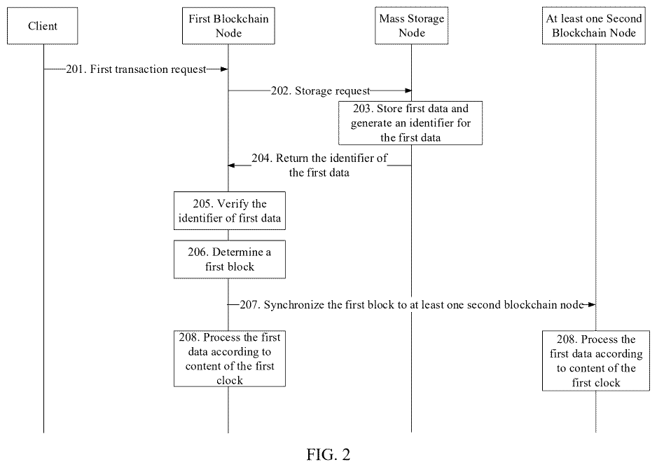

In one possible implementation, a month ago, a user set a sales target for a product, for example, one million. One month later, the user wants to verify whether the sales target has been reached. The user (or client) sends a first transaction request to the blockchain's consensus node. This first transaction request includes a blockchain transaction type, first data, and a verification identifier. The blockchain transaction type is for verifying whether the sales target has been reached, and the first data is the user's sales orders for the month. The processing of the first data is shown in FIG. 2. The method includes the following step.
Step 201: The first blockchain node receives the first transaction request.
Step 202: The first blockchain node sends a storage request to the mass storage node.

In one possible implementation, the first blockchain node sends the storage request to the mass storage node, i.e., the IPFS node. The storage request includes first data, namely, the user's sales orders for one month.
Step 203: The mass storage node stores the first data and generates an identifier for the first data.

In one possible implementation, after receiving the storage request, the IPFS system stores the first data carried in the storage request to the IPFS node, and returns the identifier for the first data to the first blockchain node. The identifier for the first data is a hash value determined by the IPFS system through hash calculation based on the content of the first data.
Step 204: The IPFS system returns the identifier for the first data to the first blockchain node.
Step 205: The first blockchain node verifies the identifier for the first data.

In one possible implementation, a determination is made as to whether the verification identifier is identical to the identifier for the first data. If the verification identifier is identical to the identifier for the first data, the first blockchain node synchronizes a first block including the blockchain transaction type and the identifier for the first data to at least one second blockchain node. If not, the first blockchain node sends a message to the client indicating that the identifier verification of the first data has failed, and the user then decides whether to initiate another transaction request with the first blockchain node.
Step 206: Determine a first block.

In one possible implementation, the first blockchain node reaches consensus with at least one second blockchain node based on a consensus protocol and determines the content of a first block. For example, the first block includes information such as the blockchain transaction type, the identifier for the first data, the size of the first block, or the time the first block was generated. The first blockchain node then synchronizes the first block with the at least one second blockchain node. The first blockchain node and the at least one second blockchain node then write the first block to their respective corresponding blockchain nodes.
Step 207: The first blockchain node synchronizes the first block to at least one second blockchain node.
Step 208: The first blockchain node and the at least one second blockchain node process the first data according to content of the first block.

In one possible implementation, the first blockchain node and the at least one second blockchain node obtain the blockchain transaction type and the identifier for the first data from the first block. The first blockchain node and the at least one second blockchain node respectively send a request to obtain data to the mass storage node, namely the IPFS system, and the request to obtain data includes the identifier for the first data. The IPFS system reads the first data, namely the user's sales orders for one month, from the IPFS node according to the identifier for the first data, and returns the first data to the first blockchain node and the at least one second blockchain node respectively. The first blockchain node and the at least one second blockchain node calculate the sales amount of the month based on the user's sales orders for the month. After the calculation is completed, it is verified whether the sales amount of the month has reached the target sales amount of the product, and the verification result is returned to the user.

In one possible implementation, when the user needs to re-verify whether the monthly sales amount has reached the product sales target, the user needs to send a second transaction request to the first blockchain node. The second transaction request just needs to include the blockchain transaction type, the identifier for the first data, and the second verification identifier, and no longer needs to include the first data. After the first blockchain node receives the second transaction request and verifies the identifier for the first data, the first blockchain node reaches a consensus with at least one second blockchain node according to the consensus protocol and determines the content of the second block. For example, the second block includes information such as the blockchain transaction type, the identifier for the first data, the size of the second block, or the generation time of the second block. The first blockchain node then synchronizes the second block to the at least one second blockchain node. The first blockchain node and the at least one second blockchain node each write the second block to their respective corresponding blockchain nodes.

In one possible implementation, the first blockchain node and the at least one second blockchain node verify again whether the user's monthly sales amount has reached the product sales target amount based on the content of the second block, and return the verification result to the user.

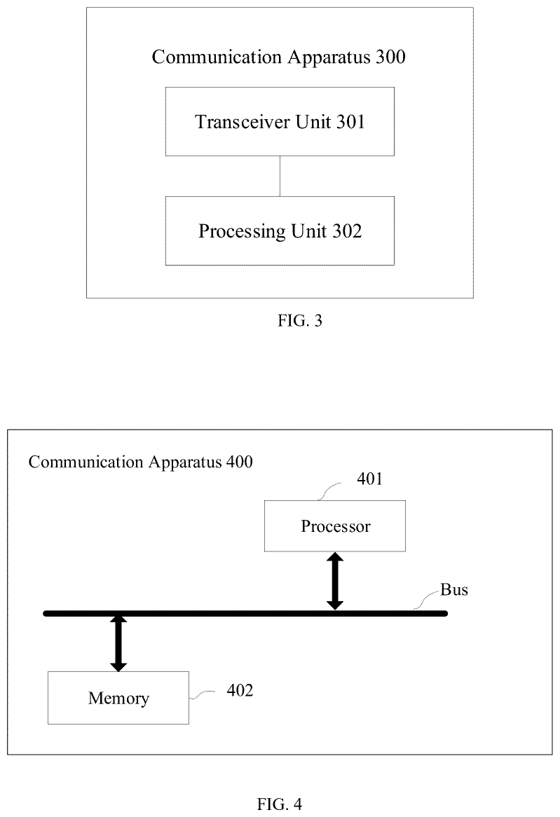

Based on the same technical concept, FIG. 3 exemplarily illustrates a communication apparatus 300, according to an embodiment of the present disclosure. As shown in FIG. 3, the communication apparatus 300 includes: a transceiver unit 301 and a processing unit 302. The transceiver unit 301 is configured to receive a first transaction request at a first blockchain node, the first transaction request including a blockchain transaction type and first data, and the blockchain transaction type indicating a processing mode for the first data. The processing unit 302 is configured to cause the first blockchain node to store the first data in a mass storage node and determine the identifier for the first data, and cause the first blockchain node to synchronize a first block including the blockchain transaction type and the identifier for the first data to at least one second blockchain node.

In one possible implementation, the processing unit 302 is further configured to cause the first blockchain node to obtain the blockchain transaction type and the identifier for the first data from the first block, cause the first blockchain node to obtain the first data from the mass storage node according to the identifier for the first data, and cause the first blockchain node to process the first data according to the blockchain transaction type.

In one possible implementation, the transceiver unit 301 is further configured to cause the first blockchain node to receive the identifier for the first data from the mass storage node.

In one possible implementation, the processing unit 302 is further configured to cause the first blockchain node to generate the identifier for the first data.

In one possible implementation, the first transaction request also includes a verification identifier.

In one possible implementation, the processing unit 302 is further configured to determine whether the verification identifier is identical to the identifier for the first data. When the verification identifier is identical to the identifier for the first data, the first blockchain node synchronizes the first block to the at least one second blockchain node.

In one possible implementation, the transceiver unit 301 is further configured to cause the first blockchain node to receive a second transaction request, where the second transaction request includes the blockchain transaction type and the identifier for the first data, and cause the first blockchain node to synchronize a second block including the blockchain transaction type and the identifier for the first data to the at least one second blockchain node.

In one possible implementation, the mass storage node refers to an IPFS node.

In one possible implementation, the first block is used by the at least one second blockchain node to process the first data according to the blockchain transaction type.

Based on the same technical concept, an embodiment of the present disclosure provides a communication apparatus 400, which may be, for example, a computing device. As shown in FIG. 4, the communication apparatus 400 includes at least one processor 401 and a memory 402 connected to the at least one processor. The specific connection medium between processor 401 and memory 402 is not limited in the embodiment of the present disclosure. FIG. 4 illustrates an example of a bus connection between the processor 401 and the memory 402. The bus may be classified into one of the address buses, data buses, and control buses.

In an embodiment of the present disclosure, the memory 402 stores instructions that may be executed by the at least one processor 401, and the at least one processor 401 may execute the above-described blockchain-based communication method by executing the instructions stored in the memory 402.

The processor 401 is the control center of the communication apparatus 400, connecting various components of the computer device via various interfaces and lines. The processor 401 performs resource configuration by running or executing instructions stored in the memory 402 and accessing data stored in the memory 402. Optionally, the processor 401 may include one or more determination units. The processor 401 may integrate an application processor and a modem processor, where the application processor primarily processes the operating system, user interface, and application programs, while the modem processor primarily handles wireless communications. It is to be noted that the modem processor may not be integrated into the processor 401. In some embodiments, the processor 401 and the memory 402 may be implemented on the same chip. In some embodiments, the processor 401 and the memory 402 may also be implemented on separate chips.

The processor 401 may be a general purpose processor, such as a central processing unit (CPU), a digital signal processor, an application specific integrated circuit (ASIC), field programmable gate array (FPGA) or other programmable logic devices, discrete gate or transistor logic device, or discrete hardware components, and may implement or execute the methods, steps, and logic block diagrams disclosed in the embodiments of the present disclosure. A general-purpose processor may be a microprocessor or any conventional processor. The steps of the methods disclosed in the embodiments of the present disclosure may be directly implemented and executed by a hardware processor, or by a combination of hardware and software modules in the processor.

The memory 402 is a non-volatile computer-readable storage medium that may be configured to store non-volatile software programs, non-volatile computer executable programs, and modules. The memory 402 may include at least one type of storage medium, such as a flash memory, a hard disk, a multimedia card, a card-type memory, a random access memory (RAM), a static random access memory (SRAM), programmable read-only memory (PROM), read-only memory (ROM), electrically erasable programmable read-only memory (EEPROM), magnetic storage, magnetic disk, optical disk, etc. The memory 402 is any other medium that may be used to carry or store desired program code in the form of instructions or data structures and may be accessed by a computer, but is not limited thereto. The memory 402 in the embodiments of the present disclosure may also be a circuit or any other device that may implement a storage function and is configured to store program instructions and/or data.

An embodiment of the present disclosure also provides a computer-readable storage medium, which stores a computer-executable program. The computer-executable program is configured to enable a computer to execute a blockchain-based communication method described in any of the above methods.

An embodiment of the present disclosure provides a computer program product, including a computer program executable by a computer device. When the program is run on the computer device, the computer device executes a blockchain-based communication method described in any of the above methods.

Those skilled in the art will appreciate that the embodiments of the present disclosure may be provided as methods, systems, or computer program products. Therefore, the present disclosure may take the form of a complete hardware embodiment, a complete software embodiment, or an embodiment combining software and hardware. Furthermore, the present disclosure may take the form of a computer program product implemented on one or more computer-usable storage media (including but not limited to magnetic disk storage, CD-ROM, optical storage, etc.) including computer-usable program code.

The present disclosure is described with reference to the flowcharts and/or block diagrams of the methods, devices (systems), and computer program products according to the present disclosure. It should be noted that each box and/or block in the flowchart and/or block diagram, as well as the combination of the box and/or block in the flowchart and/or block diagram, may be implemented by computer program instructions. These computer program instructions may be provided to a processor of a general-purpose computer, a special-purpose computer, an embedded processor, or other programmable data processing devices to produce a machine, so that the instructions executed by the processor of the computer or other programmable data processing devices produce a device for implementing the functions specified in one or more boxes in the flowchart and/or one or more blocks in the block diagram.

These computer program instructions may also be stored in a computer-readable memory that may direct a computer or other programmable data processing devices to operate in a specific manner, so that the instructions stored in the computer-readable memory produce a product including an instruction device that implements the functions specified in one or more processes in one or more boxes in the flowchart and/or one or more blocks in the block diagram.

These computer program instructions may also be loaded onto a computer or other programmable data processing devices, so that a series of operating steps are executed on the computer or other programmable devices to produce a computer-implemented process, thereby performing a computer-implemented process on the computer or other programmable devices. The instructions executed on other programmable devices provide steps for implementing the functions specified in one or more boxes of the flowcharts and/or one or more blocks of the block diagrams.

Apparently, those skilled in the art may make various changes and modifications to the present disclosure without departing from the spirit and scope of the present disclosure. Thus, if these modifications and variations of the present disclosure fall within the scope of the claims of the present disclosure and their equivalents, the present disclosure is intended to include these modifications and variations.

1. A blockchain-based communication method, comprising:
a first blockchain node receiving a first transaction request, the first transaction request including a blockchain transaction type and first data, the blockchain transaction type indicating a processing mode for the first data;
the first blockchain node storing the first data in a mass storage node and determining an identifier for the first data; and
the first blockchain node synchronizing a first block containing the blockchain transaction type and the identifier for the first data to at least one second blockchain node.

2. The method according to claim 1, further comprising:
the first blockchain node obtaining the blockchain transaction type and the identifier for the first data from the first block;
the first blockchain node obtaining the first data from the mass storage node based on the identifier for the first data; and
the first blockchain node processing the first data based on the blockchain transaction type.

3. The method according to claim 1, wherein the first blockchain node determining the identifier for the first data comprises:
the first blockchain node receiving the identifier for the first data from the mass storage node.

4. The method according to claim 1, wherein the first blockchain node determining the identifier for the first data comprises:
the first blockchain node generating the identifier for the first data.

5. The method according to claim 1, wherein the first transaction request further includes a verification identifier, and the method further comprises:
determining whether the verification identifier is identical to the identifier for the first data; and
the first blockchain node synchronizing the first block including the blockchain transaction type and the identifier for the first data to the at least one second blockchain node, including:
when the verification identifier is identical to the identifier for the first data, the first blockchain node synchronizing the first block to the at least one second blockchain node.

6. The method according to claim 1, further comprising:
the first blockchain node receiving a second transaction request, the second transaction request including the blockchain transaction type and the identifier for the first data; and
the first blockchain node synchronizing a second block including the blockchain transaction type and the identifier for the first data to the at least one second blockchain node.

7. The method according to claim 1, wherein the mass storage node is an InterPlanetary File System (IPFS) node.

8. The method according to claim 1, wherein the first block is used by the at least one second blockchain node to process the first data based on the blockchain transaction type.

9. A communication apparatus, comprising a transceiver unit and a processing unit, wherein:
the transceiver unit is configured to receive a first transaction request at a first blockchain node, the first transaction request including a blockchain transaction type and first data, the blockchain transaction type indicating a processing mode for the first data; and
the processing unit is configured to store the first data in a mass storage node and determine an identifier for the first data, and the first blockchain node synchronizes a first block including the blockchain transaction type and the identifier for the first data to at least one second blockchain node.

10. A computing device, comprising:
a memory for storing program instructions; and
a processor for calling the program instructions stored in the memory and executing a blockchain-based communication method in accordance with the obtained program instructions, and the method comprising:
a first blockchain node receiving a first transaction request, the first transaction request including a blockchain transaction type and first data, the blockchain transaction type indicating a processing mode for the first data;
the first blockchain node storing the first data in a mass storage node and determining an identifier for the first data; and
the first blockchain node synchronizing a first block containing the blockchain transaction type and the identifier for the first data to at least one second blockchain node.

11. The computing device according to claim 10, wherein the method further comprises:
the first blockchain node obtaining the blockchain transaction type and the identifier for the first data from the first block;
the first blockchain node obtaining the first data from the mass storage node based on the identifier for the first data; and
the first blockchain node processing the first data based on the blockchain transaction type.

12. The computing device according to claim 10, wherein the first blockchain node determining the identifier for the first data comprises:
the first blockchain node receiving the identifier for the first data from the mass storage node.

13. The computing device according to claim 10, wherein the first blockchain node determining the identifier for the first data comprises:
the first blockchain node generating the identifier for the first data.

14. The computing device according to claim 10, wherein the first transaction request further includes a verification identifier, and the method further comprises:
determining whether the verification identifier is identical to the identifier for the first data; and
the first blockchain node synchronizing the first block including the blockchain transaction type and the identifier for the first data to the at least one second blockchain node, including:
when the verification identifier is identical to the identifier for the first data, the first blockchain node synchronizing the first block to the at least one second blockchain node.

15. The computing device according to claim 10, wherein the method further comprises:
the first blockchain node receiving a second transaction request, the second transaction request including the blockchain transaction type and the identifier for the first data; and
the first blockchain node synchronizing a second block including the blockchain transaction type and the identifier for the first data to the at least one second blockchain node.

16. The computing device according to claim 10, wherein the mass storage node is an InterPlanetary File System (IPFS) node.

17. The computing device according to claim 10, wherein the first block is used by the at least one second blockchain node to process the first data based on the blockchain transaction type.
